(19) United States
(12) Patent Application Publication
(10) Pub. No.: US 2009/0158011 A1
(43) Pub. Date: Jun. 18, 2009

(54) DATA PROCESSING SYSTEM

(75) Inventors: Gerard David Jennings, Munich (DE); Wieland Fischer, Munich (DE)

Correspondence Address: DICKSTEIN SHAPIRO LLP, 1177 AVENUE OF THE AMERICAS 6TH AVENUE, NEW YORK, NY, 10036-2714, US

(73) Assignee: Infineon Technologies AG, Neubiberg (DE)

(21) Appl. No.: 11/956,789

(22) Filed: Dec. 14, 2007

(51) Int. Cl. G06F 7/38

(52) U.S. Cl. 712/220

(57) ABSTRACT

A data processing system comprising a computer chip having a processing circuit and a chip-internal first memory and a chip-external second memory being coupled to the computer chip, wherein the processing circuit is configured to allow execution of computer programs stored in the first memory and to prevent execution of computer programs stored in the second memory when the data processing system is in a first state, and to allow execution of computer programs stored in the second memory when the data processing system is in a second state.

### TECHNICAL FIELD

Embodiments of the invention relate generally to a data processing system.

### BACKGROUND

In electronic communication devices such as mobile communication terminals, there is often the need to provide the security for certain applications or data, such as applications for carrying out cryptographic operations. It is desirable to provide processing systems which, on the one hand, provide high security for applications and data that should be protected but where, on the other hand, secure resources are not wasted for applications or data that are not necessary to be protected.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows an electronic computing device according to an embodiment of the invention;

FIG. 2 shows an operating state diagram according to an embodiment of the invention;

FIG. 3 shows a security circuit according to an embodiment of the invention; and

FIG. 4 shows a flow diagram according to an embodiment of the invention.

### DESCRIPTION

In many electronic computing devices, such as mobile phones, secure execution environments are necessary for performing tasks which are security related for example in which confidential data is processed. In the example of mobile phones, mobile network operators and mobile phone manufactures may require a secure execution environment for loading a secure application, i.e. an application that may not be altered by a user, into a mobile phone. Such an application is for example loaded into a mobile phone when the mobile phone is manufactured or it may be downloaded by the user of the mobile phone himself.

Such an application for example processes confidential data such as cryptographic keys. For example, it should not be possible for an attacker (attacking user) to extract such a cryptographic key from the mobile phone. Therefore, the cryptographic key should be protected from attacks by un-trusted software and from physical attacks such as probing or modification of information signals for example between the main processing component of the mobile phone and memory components of the mobile phone such as a DRAM (Dynamic Random Access Memory) or a non-volatile memory of the mobile phone.

It may also be desirable that secure applications, i.e. the applications trusted for example by the operator of the mobile communication network for which the mobile phone is used as user terminal, are isolated from each other such that for example one of the secure applications does not have access to the data processed by another one of the secure applications.

A general purpose secure execution environment is typically relatively complex (also it is typically less complex than the main operating system of the mobile phone or generally the electronic computing device) and typically has a relatively large memory footprint, i.e. for example high memory requirements. Additional secure execution environments may be used for protecting confidential data from software attacks. Protection from hardware attacks may be taken into account by execution of the whole secure execution environment from an on-chip memory (or a stacked memory), i.e. a memory which is part of the same chip as for example the main processing circuit of the mobile phone and is thus secure against software or hardware attacks. However, this typically increases the cost of the chip providing the secure execution environment.

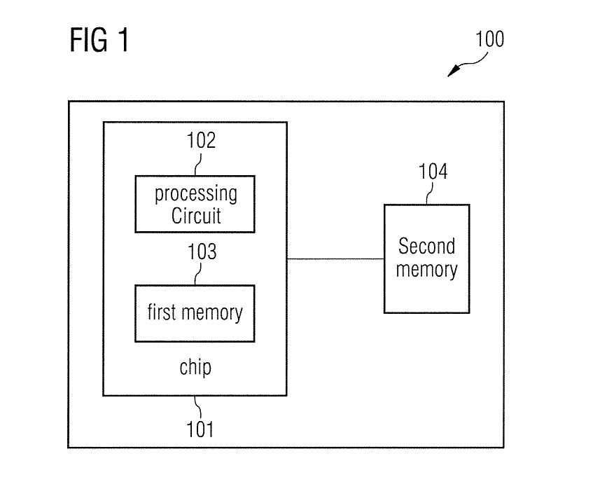

An embodiment of the invention in which confidential data may be protected against software and hardware attacks and which may also be provided at low costs will be explained in the following with reference to FIG. 1.

FIG. 1 shows an electronic computing device 100 according to an embodiment of the invention.

The electronic computing device 100 is for example a mobile phone or generally a mobile electronic device such as a PDA (Personal Digital Assistant). It may also be a personal computer system such as a laptop or a desktop computer or also a work station or a server computer being operated in a communication network such as the Internet.

The electronic computing device 100 may include a computer chip 101 including a processing circuit 102, for example a microprocessor, e.g. a general purpose processor controlling the operation of the electronic computing device, and a first memory 103. This means that the first memory 103 is a chip-internal memory of the electronic computing device 100, in this example part of the same computer chip as the processing circuit 102.

The electronic computing device 100 further includes a second memory 104 which is not part of the computer chip 101 and is therefore a chip-external memory. The second memory 104 may be a memory which is an external memory of the electronic computing device 100 and is for example coupled to the electronic computing device via a memory bus, (which may be a serial bus or a parallel bus) for example according to USB (Universal Serial Bus) or any other suitable communication connection for data transfer. In this example, the second memory 104 is coupled to the computer chip 101 via an internal memory bus of the electronic computing device.

The processing circuit 102 is configured to allow execution of computer programs stored in the first memory 103 and to prevent execution of computer programs stored in the second memory 104 when the electronic computing device 100, which may generally be a data processing system, is in a first state and to allow execution of computer programs stored in the second memory when the electronic computing device is in a second state.

This means that in the first state, which may be seen as a secure operating state of the electronic computing device 100 only computer programs of which the computer program code is stored in the first memory 103 and is therefore protected against hardware attacks may be executed. For example, confidential data such as cryptographic keys may only be processed in the first state and it is therefore guaranteed that only computer programs which are protected against hardware attacks may process and have access to the confidential data. In the second state, which may be seen as a less secure state than the first state, computer programs of which the code is stored in the second memory 104 may be executed. For example, in the second state, confidential data may not be processed.

A memory used in the embodiments of the invention may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, e.g., a floating gate memory, a charge trapping memory, an MRAM (Magnetoresistive Random Access Memory) or a PCRAM (Phase Change Random Access Memory).

In the context of this description, a “volatile memory cell” may be understood as a memory cell storing data, the data being refreshed during a power supply voltage of the memory system being active, in other words, in a state of the memory system, in which it is provided with power supply voltage. In an embodiment of the invention, a “volatile memory cell” may be understood as a memory cell storing data, the data being refreshed during a refresh period in which the memory cell is provided with a power supply voltage corresponding to the level of the stored data.

A “non-volatile memory cell” may be understood as a memory cell storing data even if it is not active. In an embodiment of the invention, a memory cell may be understood as being not active e.g. if currently access to the content of the memory cell is inactive. In another embodiment, a memory cell may be understood as being not active e.g. if the power supply is inactive. Furthermore, the stored data may be refreshed on a regular timely basis, but not, as with a “volatile memory cell” every few picoseconds or nanoseconds or milliseconds, but rather in a range of hours, days, weeks or months. Alternatively, the data may not need to be refreshed at all in some designs.

A circuit may be a hardware circuit, e.g. an integrated circuit, designed for the respective functionality or also a programmable unit, such as a processor, programmed for the respective functionality. A processor may for example be a RISC (reduced instruction set computer) processor or a CISC (complex instruction set computer). A logic may for example be implemented using a circuit.

In one embodiment, the data processing system further includes a third memory in which data is stored and the processing circuit is configured to allow access to the data when the data processing system is in the first state and to prevent access to the data when the data processing system is in the second state. The third memory is for example a chip-internal memory. The data is for example cryptographic data, e.g. includes a cryptographic key.

In one embodiment, the data processing system further includes a security circuit which is in a first security circuit state when the data processing system is in the first state and which is in a second security circuit state when the data processing system is in the second state. The security circuit is for example configured to process secret data when it is in the first security circuit state and to not process the secret data when it is in the second security circuit state. The security circuit may be configured to allow access to the processed secret data when it is in the second security circuit state. Further, the security circuit may be configured to not allow access to the secret data when it is in the second security circuit state.

The second memory is for example protected against software attacks. The data processing system is for example part of an electronic computing device, e.g. a mobile electronic computing device such as a mobile communication device.

In one embodiment, the processing circuit executes a control computer program which controls whether computer programs stored in the first memory and computer programs stored in the second memory are allowed to be executed. The code of the control computer program is for example stored in the first memory.

The computer chip for example implements a system-on-chip including the processing circuit and the first memory.

In one embodiment, a data processing system is provided that includes a computer chip having a processing circuit and a chip-internal first memory; a chip-external second memory being coupled to the computer chip; and an access control circuit configured to grant or deny access to resources of the data processing system depending on whether the access is requested by a computer program the code of which is stored in the first memory or by a computer program the code of which is stored in the second memory.

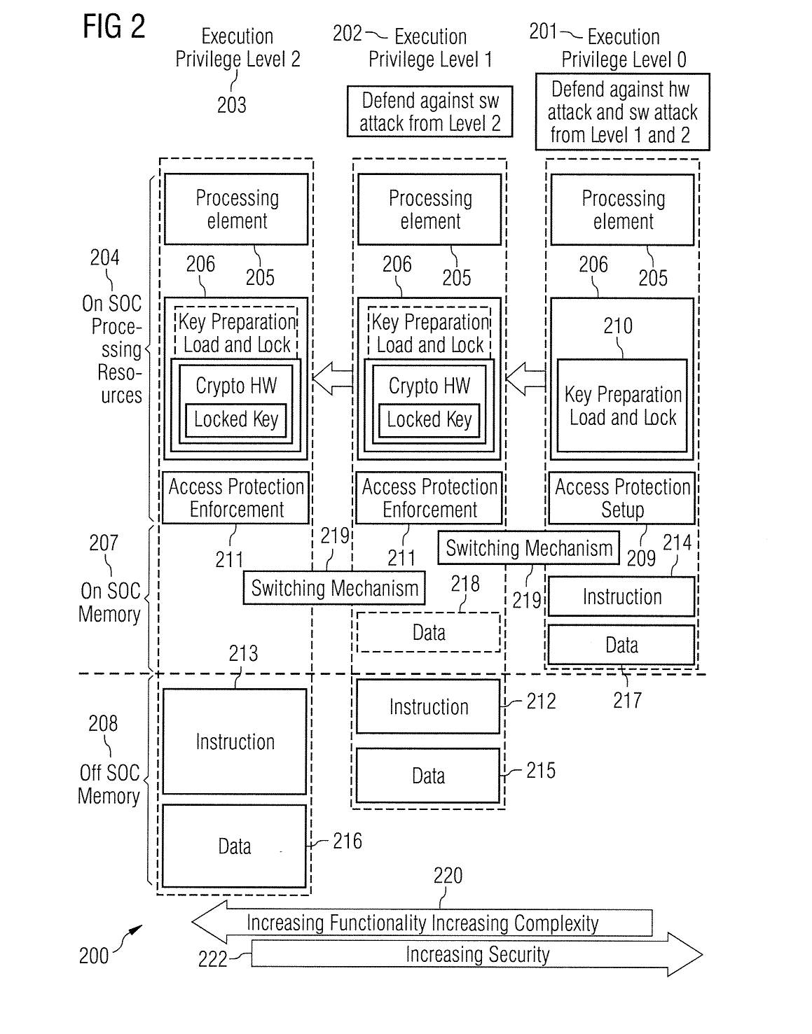

The electronic computing device 100 may have more than two operating states which define which computer programs are allowed to be executed by the electronic computing device 100, for example by the processing circuit 102. An embodiment where there are three different operating states, which are called execution privilege levels is described in the following with reference to FIG. 2.

FIG. 2 shows an operating state diagram 200 according to an embodiment of the invention.

Three operating states are illustrated as an example. A first operating state is denoted as execution privilege level 0 201, a second operating state is denoted as execution privilege level 1 202 and a third operating state is denoted as execution privilege level 2 203.

For each execution privilege level 201, 202, 203 the available resources of the electronic computing device are illustrated. A resource of the electronic computing device is available in an execution privilege level 201, 202, 203 if it may be accessed, for example in the case that the resource is data stored in the electronic computing device 100, if it may be used by computer programs executed in the execution privilege level, for example in the case that the resource is a processing component or, in the case that the resource is computer program code stored in a memory or a memory area, if the computer program may be executed. This means that depending on the execution privilege level in which the electronic computing device 100 is currently in, computer programs from certain memories or memory areas are allowed to be executed or are prevented from being executed.

This means that resources may be hardware resources such as processing components or memory but also software resources such as computer programs or data.

Resources of the electronic computing device 100 may include on-chip processing resources 204, i.e. processing components of the electronic computing device 100 which are part of the computer chip 101 which may form a system on-chip (SoC), such as a processing element 205, which in this example corresponds to the processing circuit 102, and a security circuit 206. Resources of the electronic computing device may further include on-chip memory 207 corresponding to the first memory 103 in FIG. 1 and off-chip memory 208 which corresponds to the second memory 104 but may also include other internal and external memories of the electronic computing device 100.

The execution privilege level 0 201 (in other words the execution environment with privilege level 0) is, illustratively, a very small execution environment and is for example limited in its functionality to setting up the access protection of the electronic computing device 100 (this function is illustrated in block 209 in FIG. 2) providing cryptographic services and managing the security of the electronic computing device 100. For example, the functionality of the execution privilege level 0 201 includes run-time integrity checking.

In the execution privilege level 0 201 only the on-chip memory 207 is used. This means that for example security functionalities provided in execution privilege level 0 201, which are for example provided by the security circuit 206 only use the on-chip memory 207 for processing and that only computer programs the code of which is stored in the on-chip memory 207 are executed. This means that computer programs whose code is stored in the off-chip memory 208 are not allowed to be executed, for example by the processing element 205, when the electronic computing device 100 is the execution privilege level 0 201. In execution privilege level 0 201, for example all of the access protection hardware of the electronic computing device, is set up. This access protection hardware for example controls which resources of the electronic computing device 100 are available in the various execution privilege levels 201, 202, 203.

For example, cryptographic functionalities which make use of the confidential data such as a secret key are provided in execution privilege level 0 201. In one embodiment, in execution privilege level 0 201 only resources of the electronic computing device 100 are available which are part of the chip 101. Therefore, the execution privilege level 0 201 may be considered as an on-chip security environment.

The execution privilege level 0 201 is for example the execution environment which is entered when the electronic computing device 100 is started, i.e. is set up during the system boot. The system boot is for example implemented in such a way that it is part of the secure boot where only cryptographically authenticated program code is executed or where the program code is integrity protected. The secure boot is a process of the execution privilege level 0 201. This means for example that during the secure boot only program code that is stored in the on-chip memory 207 may be executed.

The access protection set up 209 carried out in execution privilege level 0 201 for example includes assigning memories or memory areas (both on-chip and off-chip) and peripherals, or generally resources of the electronic computing device 100 to the execution privilege levels 201, 202, 203. Once configured in this way, an access control logic, which may be an on-chip component of the computer chip 101, or may be implemented by a computer program the code of which is stored in the on-chip memory 206 ensures that the recourses of the electronic computing device 100 are only accessed in the correct execution privilege level. For example, it may be defined that the security circuit which holds a secret cryptographic key (root key) can only be accessed in execution privilege level 0. The security circuit 206 can for example use the secret cryptographic key in execution privilege level 0 201 for unwrapping and preparation of other cryptographic keys. These other cryptographic keys may then be loaded (e.g. in the on-chip memory 207 or in a memory of the security circuit 206), locked (i.e. protected against alteration in execution privilege level 1 202 and execution privilege level 2 203). This functionality of the cryptographic circuit 206 in execution privilege level 0 is illustrated by block 210 in FIG. 2. After the other cryptographic keys have been locked, the security circuit 206 may be released to the domain of the execution privilege level 1 202, i.e. it may now be accessible in execution privilege level 1 202. Generally, the execution privilege level 1 202 may make use of security services provided by the execution privilege level 0 201.

The functionality of the access control logic in execution privilege levels 1 and 2 202, 203, i.e. the prevention of access to resources of the electronic computing device 100 in execution privilege levels in which the access is not allowed is illustrated by blocks 211 in FIG. 2.

The off-chip memory 208 may be divided in memory areas which are available depending on the current execution privilege levels 201, 202, 203. In this example, in a first memory area 212 of the off-chip memory 208 computer program code is stored which may be executed in execution privilege level 1 202 but which may not be executed in execution privilege level 0 201. In a second memory area 213 computer program code is stored which may be executed in execution privilege level 2 but which may not be executed in execution privilege levels 1 and 0 201, 202. The computer program code 214 which may be executed in execution privilege level 0 201 is, as explained above, stored in on-chip memory 207.

In a third memory area 215 of the off-chip memory 208 data is stored which may be accessed in execution privilege levels 1 and 0 201, 202 but which may not be accessed in execution privilege level 2 203. In a third memory area 215 of the off-chip memory 208 data is stored which may be accessed in all three execution privilege levels 201, 202, 203. Data stored in the on-chip memory 207, illustrated by block 217 in FIG. 2 may be accessed in execution privilege level 0 201. However, there may be an on-chip memory area 218 in which data is stored which may also be accessed in execution privilege level 1 202 but which may not be accessed in execution privilege level 2 203. Program code or data which is stored in off-chip memory 208 may not be executed in privilege level 0. However, in one embodiment, program code or data stored in off-chip memory 208 may be loaded into on-chip memory 207 in privilege level 0 but the code may only be executed and the data consumed, i.e. accessed, after it has passed a test for integrity and authenticity.

Note that in another embodiment of the invention there may be a difference between data and computer program code with respect to the access right of the execution privilege levels 201, 202, 203. While data which may be accessed in an execution privilege level 201, 202, 203 may also be accessed in any execution privilege level which is more secure, e.g. data accessible in execution privilege level 1 202 may also be accessed in execution privilege level 0 201, this is not the case of computer program code, e.g. there may be computer program code that may be executed in execution privilege level 1 202 but that is not allowed to be executed in execution privilege level 0 201, but might be allowed to be executed in execution privilege level 2 203. This means that the computer program code that is allowed to be executed is being limited when getting to a higher (i.e. more secure) execution privilege level. In other words, in contrast to other resources of the electronic computing device 100, the access rights with respect to computer program code are reduced when getting to a more secure execution privilege level. For achieving highest security, however, it may in other embodiments (such as the one described above) not be allowed to access data in a execution privilege level that may also be accessed in an execution privilege level that is less secure.

Data which may only be accessed in execution privilege level 0 201 is for example a root secret cryptographic key which is used for unwrapping and key preparation of other cryptographic keys which may, when locked, may be accessed in execution privilege level 1 202.

The switching between the execution privilege levels 201, 202, 203, illustrated by the blocks 219 in FIG. 2, is controlled by an on-chip component or by a computer program the code of which is stored in the on-chip memory 207. As mentioned above, computer programs running in execution privilege level 1 202 (the code of which is for example stored in the first memory area 212) may make use of cryptographic keys unwrapped and prepared in execution privilege level 0 201 but may not extract them. The computer programs running in execution privilege level 1 202 are in one embodiment protected from software attacks, e.g. by computer programs which are allowed to be executed in execution privilege level 2 203, for example by making the first memory area 212 inaccessible in execution privilege level 2 203. A correctness and/or integrity check of the computer programs stored in the first memory area 212 may be carried out at boot time or also at run-time. For example, a computer program which is executed in execution privilege level 0 201 could perform run-time checking of computer programs stored in the first memory area 212 and being executed in execution privilege level 1 202.

The checking the computer program code of computer programs of the execution privilege level 1 domain 202, i.e. computer programs which may be executed in execution privilege level 1 202, allows the detection of physical attacks on the code of these computer programs, e.g. detection of alteration of the first memory area 212. The physical attack on the off-chip memory 208 does not compromise the security of the computer programs which are allowed to be executed in execution privilege level 0 201 since these computer programs are stored in on-chip memory 207 and by alteration of the off-chip memory 208 only computer programs may be altered which are not allowed to be executed in execution privilege level 0 201. Therefore, for example, it is not possible by physical attack on the off-chip memory 208 to gain access to components of the electronic computing device 100 which are only accessible in execution privilege level 0 201 since computer programs stored in the off-chip memory 208 can not elevate themselves to execution privilege level 0 201 and therefore have no access to resources only available in execution privilege level 0 201.

Compared to computer programs executed in execution privilege level 0 201 computer programs allowed to be executed in execution privilege level 1 202 have more limited access to the security circuit 206. Data which is accessible in execution privilege level 1 202 may also be stored in the on-chip memory area 218 for confidentiality to prevent basic bus snooping attacks. In one embodiment of the invention, all manipulation of confidential data may only be allowed in execution privilege level 0 201. Cryptographic keys and data of lower sensitivity may be accessible in execution privilege level 1 202. In execution privilege level 2 203, computer programs stored in the second memory area 213 of the off-chip memory 208 may be executed. In one embodiment, the second memory area 213 is also protected from software attacks by an access control logic but is somewhat less protected than the computer program code stored in the first memory area 212.

By providing different execution privilege levels, the amount of on-chip memory 207 can be kept at a minimum. For example, only the most critical program code and data are stored in the on-chip memory 207 and are only accessible in execution privilege level 0 201. In execution privilege level 1 202, computer program code stored in chip external memory may be executed which is not protected against hardware attacks but from which the critical program code and data are isolated.

As illustrated by block 220 in FIG. 2, the functionality and complexity increase from execution privilege level 0 201 to execution privilege level 2 203 via execution privilege level 1 202. On the other hand, as illustrated by block 221, security increases from execution privilege level 2 203 to execution privilege level 0 201 via execution privilege level 1 202.

As mentioned above, in the security circuit 206, secret data, such as a root cryptographic key, may be stored. This security of the electronic computing device 100 may strongly depend on the security and the secure use of this secret data. As a measure for ensuring the secure use of the secret data, as explained above, only software which is deemed secure, in this example computer programs which are stored in on-chip memory 207, have access to the secret data stored in the security circuit. In one embodiment, this software is kept as simple as possible since high complexity may lead to reduction of the security of the electronic computing device. Less secure software, such as computer programs that are allowed to be executed in execution privilege levels 1 and 2 202, 203 may require use of functionalities of the security circuit 206 in order to accelerate some processes, for example for accelerating decryption, encryption or cryptographic signing of data. The less secure software does not necessarily need to make use of the secret data stored in the security circuit.

If the secret data is for example a root key, as explained above, other cryptographic keys may be unwrapped and locked in execution privilege level 0 201 and the computer programs executed in execution privilege level 1 202 may make use of the other cryptographic keys. Generally, the less secure software may make use of secret data specific to its application (which is for example somewhat less secure, e.g. the other cryptographic keys) which are derived from the secret data stored in the security circuit 206. In one embodiment of the invention, a way is provided for passing the derived secure data to the less secure software and to allow the less secure software to make use of the security circuit 206 without making the secret data stored in the security circuit 206 which is denoted as root secret data in the following, for example a root key, vulnerable.

If the derived secret data (e.g. the other cryptographic key derived from the root key) are passed to the less secure software and the less secure software may make direct use of the derived data the derived secret data may be vulnerable.

If the less secure software is given access to the security circuit 206 via a security driver, the more software (especially complex software) that interfaces with the security driver, the greater the chance of the security breach is. When the security circuit 206 is used in a state where the root secret data stored in the security circuit 206 is accessible, i.e. in execution privilege level 0 201, the highest security measure is taken, for example interrupts during accesses are disabled in execution privilege level 0 201 and cashes are flushed when execution privilege level 0 201 is exit, it may be an acceptable performance loss when execution privilege level 0 201 is entered each time the security circuit 206 should be accessed. This performance loss may not be viewed as an acceptable trade-off in view of the sensitivity of the data which is currently processed and may for example also be processed in execution privilege level 1 202.

Therefore, in one embodiment, different access levels for the different execution privilege levels 201, 202, 203 are provided for the security circuit 206. For example, in execution privilege level 0 201 the security circuit 206 is in a secure state, in which it for example may process a root key and unwrap and prepare cryptographic keys. In addition the security circuit 206 may have a non-secure state which it enters when the electronic computing device is in execution privilege level 1 or 2 202, 203 and in which the root secret data may not be processed by the security circuit 206. This allows the derived secret data to be securely derived from the root secret data and then be passed to software executed in execution privilege levels 1 or 2 202, 203 when the security circuit 206 is in the non-secure state.

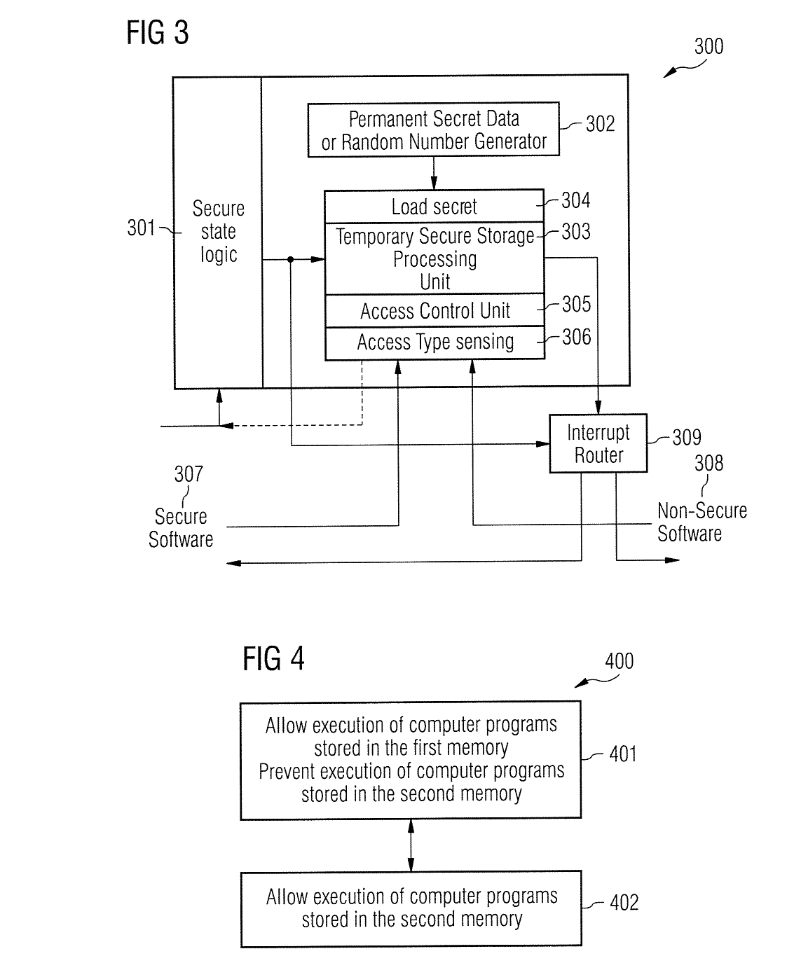

The derived secret data never leaves the security circuit but is pre-loaded in execution privilege level 0 201 for use by the less secure software, i.e. software allowed to be executed in execution privilege levels 1 or 2 202, 203. The less secure software may for example use the derived secret data but may not read it out or change it (which might otherwise lead to a drop of security in some cases). Further, the less secure software has no access to the root secret data stored in the security circuit 206. A possible implementation of the security circuit 206 is shown in FIG. 3.

FIG. 3 shows a security circuit 300 according to an embodiment of the invention.

As mentioned above, the security circuit 300 may be operated in two (or more) security states. A secure state logic 301 controls in which a state the security circuit 300 is currently in. This secure state logic 301 may for example cooperate with the access control logic that controls resources of the electronic computing device which are accessible in the current execution privilege level. For example, the access control logic determines that in the current execution privilege the secure circuit 300 is only accessible in non-secure state and instructs the secure state logic 301 to switch the security circuit into non-secure state. It is assumed that the security circuit 300 has a secure state in which the security circuit 300 is for example when the electronic computing device 100 is in execution privilege level 0 201 and the non-secure state in which the security circuit 206 is when the electronic computing device 100 is in execution privilege level 1 or 2 202, 203.

When in secure state, the security circuit may load root secret data 302 into a temporary secure storage, e.g. a register of a processing circuit 303 of the security circuit 300. The load operation of the secret data 302 is illustrated by block 304 in FIG. 3. The root secret data 302 may also be the output of a random number generator of the security circuit 300.

The processing circuit 303 provides the cryptographic functionalities of the security circuit 300. The access to these functionalities may be controlled by an access control circuit 305 which may not be part of the security circuit 300 (i.e. may be external) and may be implemented by the access control logic controlling access to the resources of the electronic computing device 100 described above. For the decision whether the security circuit 300 may be accessed an access type sensing 306 is carried out, e.g. it is determined in which execution privilege level the electronic computing device 100 is currently in or whether secure software 307 (which may only be executed in execution privilege level 0 201 or non-secure software 308 (which is for example executed in execution privilege level 1 202) wants to access the security circuit 300.

In secure state, the security circuit 300 may load the root secret data and use the root secret data, for example root secret data permanently stored in the security circuit 300 and may load and use data derived from the root secret data, for example other cryptographic keys derived from a root cryptographic key.

The security circuit 300 enters the secure state for example when it receives an external signal, for example from the access control logic of the electronic computing device 100, or when there is an access to the security circuit 300 which is deemed to be secure, for example due to the fact that the electronic computing device 100 is in execution privilege level 0 201. When the secure circuit 300 is in secure state, a non-secure access to the security circuit 300 is prevented, for example by the access control logic 305 or, in one embodiment, is allowed but all secure data in the security circuit 300 is deleted (e.g. before the access takes place). A series of secure access to the security circuit 300 is also denoted as secure thread.

When the security circuit 300 is in secure state, interrupts may be re-routed by an interrupt router 309 such that only a secure software driver may be interrupted, e.g. that an interrupt leads to the execution of a secure interrupt routine. In one embodiment, once derived secure data is ready to be passed on to less secure software, secure software, for example a computer program executed in execution privilege level 0 201, writes a bit into the security circuit 300 which allows non-secure accesses to take place without causing the derived secret data and the security circuit 300 to be deleted. The secure software may also write a bit into the security circuit 300 that causes interrupts to be routed to a non-secure software driver. This re-routing of interrupts to the non-secure software driver can also be set by the security circuit 300 when it leaves the secure state.

In one embodiment, where non-secure accesses to the security circuit 300 are not prevented when the security circuit 300 is in secure state, but, as mentioned above, secret data stored in the security circuit 300 is deleted in case of a non-secure access, the security circuit 300 indicates this security breach with the a secure interrupt routine or by setting a protected status bit in the security circuit 300 (which can for example only be cleared, i.e. reset, by a secure access to the security circuit 300). This allows secure software threads to be made aware of an attack or malfunction and prevents so called “man in the middle” type attacks.

A method for operating a data processing system comprising a computer chip having a processing circuit and a chip-internal first memory and a chip-external second memory being coupled to the computer chip according to one embodiment of the invention is illustrated in FIG. 4.

FIG. 4 shows a flow diagram 400 according to an embodiment of the invention.

In 401, which corresponds to the data processing system being in a first state, execution of computer programs stored in the first memory is allowed and execution of computer programs stored in the second memory is prevented.

In 402, which corresponds to the data processing system being in a second state, execution of computer programs stored in the second memory is allowed.

While the invention has been particularly shown and described with reference to specific embodiments, it should be understood by those skilled in the art that various change in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A data processing system comprising:
a computer chip having a processing circuit and a chip-internal first memory; and
a chip-external second memory being coupled to the computer chip;
wherein the processing circuit is configured to allow execution of computer programs stored in the first memory and to prevent execution of computer programs stored in the second memory when the data processing system is in a first state and to allow execution of computer programs stored in the second memory when the data processing system is in a second state.

2. The data processing system according to claim 1, further comprising a third memory in which data is stored, wherein the processing circuit is configured to allow access to the data when the data processing system is in the first state and to prevent access to the data when the data processing system is in the second state.

3. The data processing system according to claim 2, wherein the third memory is a chip-internal memory.

4. The data processing system according to claim 2, wherein the data is cryptographic data.

5. The data processing system according to claim 4, wherein the data comprises a cryptographic key.

6. The data processing system according to claim 1, further comprising a security circuit which is in a first security circuit state when the data processing system is in the first state and which is in a second security circuit state when the data processing system is in the second state.

7. The data processing system according to claim 6, wherein the security circuit is configured to process secret data when it is in the first security circuit state and to not process the secret data when it is in the second security circuit state.

8. The data processing system according to claim 7, wherein the security circuit is configured to allow access to the processed secret data when it is in the second security circuit state.

9. The data processing system according to claim 8, wherein the security circuit is configured to not allow access to the secret data when it is in the second security circuit state.

10. The data processing system according to claim 1, wherein the second memory is protected against software attacks.

11. The data processing system according to claim 1, further comprising an electronic computing device that comprises the data processing system.

12. The data processing system according to claim 1, further comprising a mobile electronic computing device that comprises the data processing system.

13. The data processing system according to claim 1, further comprising a mobile communication device that comprises the data processing system.

14. The data processing system according to claim 1, wherein the processing circuit is configured to execute a control computer program which controls whether computer programs stored in the first memory and computer programs stored in the second memory are allowed to be executed.

15. The data processing system according to claim 14, wherein the code of the control computer program is stored in the first memory.

16. The data processing system according to claim 1, wherein the computer chip implements a system-on-chip comprising the processing circuit and the first memory.

17. A data processing system comprising:
a computer chip having a processing circuit and a chip-internal first memory;
a chip-external second memory being coupled to the computer chip; and
an access control circuit configured to grant or deny access to resources of the data processing system depending on whether the access is requested by a computer program the code of which is stored in the first memory or by a computer program the code of which is stored in the second memory.

18. A method for operating a data processing system comprising a computer chip having a processing circuit and a chip-internal first memory, and comprising a chip-external second memory being coupled to the computer chip, the method comprising:
allowing execution of computer programs stored in the first memory and preventing execution of computer programs stored in the second memory when the data processing system is in a first state; and
allowing execution of computer programs stored in the second memory when the data processing system is in a second state.

19. The method according to claim 18, wherein the data processing system further comprises a third memory in which data is stored, and the method further comprises:
allowing access to the data when the data processing system is in the first state; and
preventing access to the data when the data processing system is in the second state.

20. The method according to claim 19, wherein the third memory is a chip-internal memory.

21. The method according to claim 19, wherein the data is cryptographic data.

22. The method according to claim 19, wherein the data comprises a cryptographic key.

23. The method according to claim 18, further comprising protecting the second memory against software attacks.

24. A method for operating a data processing system comprising a computer chip having a processing circuit and a chip-internal first memory and a chip-external second memory being coupled to the computer chip, the method comprising:
granting or denying access to resources of the data processing system depending on whether the access is requested by a computer program the code of which is stored in the first memory or by a computer program the code of which is stored in the second memory.

25. A computer program product, which, when executed by a data processing system comprising a computer chip having a processing circuit and a chip-internal first memory and a chip-external second memory being coupled to the computer chip makes the data processing system perform:
allowing execution of computer programs stored in the first memory and
preventing execution of computer programs stored in the second memory when
the data processing system is in a first state; and
allowing execution of computer programs stored in the second memory when the data processing system is in a second state.
